(19) United States
(12) Patent Application Publication
(10) Pub. No.: US 2026/0167521 A1
(43) Pub. Date: Jun. 18, 2026

(54) Cathode Active Material Precursor and Method of Preparing Cathode Active Material Using the Same

(71) Applicant: SK On Co., Ltd., Seoul (KR)

(72) Inventors: Jong Hwa KIM, Daejeon (KR); Yeong Bin YOO, Daejeon (KR); Sung Soon PARK, Daejeon (KR); Jeong Bae YOON, Daejeon (KR); Nyung Joo KONG, Daejeon (KR)

(21) Appl. No.: 19/422,628

(22) Filed: Dec. 17, 2025

(30) Foreign Application Priority Data
Dec. 18, 2024 (KR) 10-2024-0190358

(51) Int. Cl. C01G 53/84; C01G 53/506; H01M 4/525

(52) U.S. Cl. CPC C01G 53/84; C01G 53/506; H01M 4/525; C01P 2002/50; C01P 2004/03; C01P 2004/54; C01P 2006/12; C01P 2006/14; C01P 2006/16; C01P 2006/40

(57) ABSTRACT

A cathode active material precursor according to the present disclosure includes composite hydroxide particles including a plurality of pores, the composite hydroxide particles including first pores having a diameter of 2 nm or less in a volume of 0.1 to 5% by volume based on a total volume of the plurality of pores. A method of preparing a cathode active material according to the present disclosure includes first heat-treating a mixture of a cathode active material precursor and a lithium precursor, and second heat-treating. The cathode active material precursor includes composite hydroxide particles having a plurality of pores, the composite hydroxide particles including first pores having a diameter of 2 nm or less in a volume of 0.1 to 5% based on the total volume of the plurality of pores.

### CROSS-REFERENCE TO RELATED APPLICATION AND CLAIM OF PRIORITY

This application claims priority to Korean Patent Application No. 10-2024-0190358 filed on Dec. 18, 2024 in the Ministry Of Intellectual Property (MOIP), the entire disclosure of which is incorporated by reference herein.

### BACKGROUND

### 1. Field

The present disclosure relates to a cathode active material precursor and a method of preparing a cathode active material using the same.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery is actively developed and applied due to its high operating voltage, high energy density per unit weight, and advantages in charging speed and weight reduction.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

The cathode active material may be in the form of a secondary particle in which small primary particles are agglomerated, or in the form of a single particle. Depending on the particle form of the cathode active material, the electrochemical properties and cycle life properties of the secondary battery may vary.

For example, in the case of a cathode active material in the form of a secondary particle, cracks may occur during charging and discharging of the secondary battery, which may degrade the cycle life properties of the secondary battery. In the case of a cathode active material in the form of a single particle, the electrical properties of the secondary battery may be deteriorated due to residual lithium or changes in the surface structure during the manufacturing process.

### SUMMARY

An object of the present disclosure is to provide a cathode active material precursor capable of providing a secondary battery having improved electrical properties.

Another object of the present disclosure is to provide a method for preparing a cathode active material using the cathode active material precursor.

A cathode active material precursor according to the present disclosure includes composite hydroxide particles including a plurality of pores, wherein the composite hydroxide particles include first pores having a diameter of 2 nm or less in a volume of 0.1 to 5% by volume based on a total volume of the plurality of pores.

According to exemplary embodiments, the composite hydroxide particles may include second pores having a diameter of greater than 2 nm and less than 50 nm in a volume of 70 to 97% by volume based on the total volume of the plurality of pores.

According to exemplary embodiments, the composite hydroxide particles may include third pores having a diameter of 50 nm or more in a volume of 2 to 25% by volume based on the total volume of the plurality of pores.

According to exemplary embodiments, the composite hydroxide particles may have a BET surface area of 1.0 m²/g to 7.0 m²/g.

According to exemplary embodiments, the total volume of the plurality of pores of the composite hydroxide particles may be 0.001 cm³/g to 0.04 cm³/g.

According to exemplary embodiments, the composite hydroxide particles may have an aspect ratio of 1.0 to 6.0.

According to exemplary embodiments, the composite hydroxide particles may include nickel, cobalt and manganese, and the content of nickel based on the total content of metals in the composite hydroxide particles may be 80 mol % or more.

According to a method of preparing a cathode active material of the present disclosure, a mixture of a cathode active material precursor and a lithium precursor is subjected to a first heat treatment and a second heat treatment. The cathode active material precursor includes composite hydroxide particles including a plurality of pores, the composite hydroxide particles including first pores having a diameter of 2 nm or less in a volume of 0.1 to 5% by volume based on a total volume of the plurality of pores. A heat treatment profile value, according to Equation 1 below, is 0.5 to 8.

$$Heat treatment profile = ( {T}_{2} \times {t}_{2} ) / ( {T}_{1} \times {t}_{1} ) \qquad [ Equation 1 ]$$

In Equation 1, T₁ is a temperature of the first heat treatment, t₁ is a time of the first heat treatment, T₂ is a temperature of the second heat treatment, and t₂ is a time of the second heat treatment.

According to exemplary embodiments, the heat treatment profile value may be 1 to 4.

According to exemplary embodiments, the temperature of the second heat treatment may be lower than the temperature of the first heat treatment.

According to exemplary embodiments, the composite hydroxide particles may include second pores having a diameter greater than 2 nm and less than 50 nm in a volume of 70 to 97% by volume based on the total volume of the plurality of pores.

According to exemplary embodiments, the composite hydroxide particles may include third pores having a diameter of 50 nm or more in a volume of 2 to 25% by volume based on the total volume of the plurality of pores.

According to exemplary embodiments, the composite hydroxide particles may have a BET surface area of 1.0 m²/g to 7.0 m²/g.

According to exemplary embodiments, the total volume of the plurality of pores of the composite hydroxide particles may be 0.001 cm³/g to 0.04 cm³/g.

According to exemplary embodiments, the composite hydroxide particles may have an aspect ratio of 1.0 to 6.0.

According to exemplary embodiments, the temperature of the first heat treatment may be 700° C. to 1000° C.

According to exemplary embodiments, the temperature of the second heat treatment may be 600° C. to 800° C.

According to exemplary embodiments, the composite hydroxide particles include nickel, cobalt and manganese, and the content of nickel based on the total content of metals in the composite hydroxide particles may be 80 mol % or more.

According to exemplary embodiments, the composite hydroxide particles may have a flake-shaped structure.

According to exemplary embodiments, a cathode active material in a form of a single particle may be formed.

The cathode active material precursor according to embodiments of the present disclosure may include pores having a diameter within a predetermined range at a predetermined volume ratio. Accordingly, the electrical properties of the secondary battery may be improved.

The method of preparing a cathode active material according to embodiments of the present disclosure may include performing a two-step heat treatment on the cathode active material precursor. Accordingly, particle growth may be achieved, and a crystallized cathode active material may be formed, and the electrical properties of a secondary battery including the cathode active material may be improved.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are schematic plan and cross-sectional views, respectively, of a lithium secondary battery according to exemplary embodiments;

FIGS. 3A, 3B, 4A and 4B are SEM images of cathode active material precursors according to exemplary embodiments;

FIGS. 5A and 5B are SEM images of cathode active material precursors according to comparative examples;

FIG. 6 is an SEM image of a cathode active material according to an example; and

FIG. 7 is an SEM image of a cathode active material according to a comparative example.

### DETAILED DESCRIPTION OF THE INVENTION

The present disclosure provides a cathode active material precursor including composite hydroxide particles having a plurality of pores with a controlled pore volume ratio. The present disclosure also provides a method for preparing a cathode active material using the cathode active material precursor.

The cathode active material precursor and the method for preparing the cathode active material of the present disclosure may be widely applied in green technology fields, such as electric vehicles, battery charging stations, as well as solar power generation, wind power generation, and the like, which use the batteries. In addition, the cathode active material precursor and the method for preparing the cathode active material of the present disclosure may be used in eco-friendly electric vehicles, hybrid vehicles, and the like, which are aimed at mitigating climate change by reducing air pollution and greenhouse gas emissions.

Hereinafter, exemplary embodiments of the present disclosure will be described in detail with reference to the accompanying drawings. However, these embodiments are merely illustrative, and the present disclosure is not limited to the specific embodiments described as examples.

The term “single particle form” as used herein is used, for example, to exclude secondary particles formed by aggregation of a plurality of primary particles. For example, in the lithium metal oxide particles described below, it may mean excluding a secondary-particle structure in which for example, more than 10, 20 or more, 30 or more, 40 or more, 50 or more primary particles are assembled or agglomerated. However, the single particle form does not exclude a case where 2 to 10 particles are attached or closely adhered to each other to form a substantially monolithic shape (e.g., a structure converted into a single particle).

For example, in the case of the single particle, unlike the secondary particle, the boundaries of the primary particles may not be observed in SEM cross-sectional images.

For example, the secondary particle may refer to a particle in which a plurality of primary particles are agglomerated and are observed or regarded as substantially one particle. For example, in the case of the secondary particles, the boundaries of the primary particles may be observed in SEM cross-sectional images.

For example, the secondary particle may include greater than 10, 30 or more, 50 or more, or 100 or more primary particles agglomerated.

The cathode active material precursor according to the present disclosure includes composite hydroxide particles having controlled pores.

According to exemplary embodiments, the composite hydroxide particles include a plurality of pores.

The plurality of pores may be classified according to pore diameter.

According to exemplary embodiments, the plurality of pores may include a first pore having a diameter of 2 nm or less, a second pore having a diameter of greater than 2 nm and less than 50 nm, and a third pore having a diameter of 50 nm or more.

The lower limit of the diameter of the first pore is not limited, but may be, for example, 0.01 nm or more, 0.05 nm or more, or 0.1 nm or more. For example, pores that are measurable and have a diameter of 2 nm or less may be classified as the first pore.

The upper limit of the diameter of the third pore is not limited, but may be, for example, 500 nm or less, 300 nm or less, or 200 nm or less. For example, pores that are measurable and have a diameter of 50 nm or more may be classified as the third pore.

According to exemplary embodiments, the volume of the first pores may be 0.1 to 5% by volume (or 0.1 vol % to 5 vol %) based on a total volume of the plurality of pores.

In some embodiments, the volume of the first pores may be 0.3 vol % to 4.5 vol %, 0.5 vol % to 4.2 vol %, 0.6 vol % to 4.0 vol %, 0.7 vol % to 3.8 vol %, or 0.8 vol % to 3.5 vol % based on the total volume of the plurality of pores.

Within the above range, the cathode active material formed by a reaction between the composite hydroxide particles and the lithium precursor may be sufficiently grown and crystallized. Accordingly, the internal pores of the cathode active material may be reduced, and the packing property of the cathode active material may be improved, thereby enhancing the energy density of the secondary battery.

For example, if the volume of the first pores is greater than the above range, fine pores may remain inside the composite hydroxide particles, and the cathode active material may crack due to the expansion of the fine pores during charging and discharging of the secondary battery, resulting in degraded cycle life properties. For example, if the volume of the first pores is less than the above range, the composite hydroxide particles and the lithium precursor may not react uniformly, resulting in degraded electrical properties of the cathode active material.

According to exemplary embodiments, the volume of the second pores may be 70 vol % to 97 vol % based on the total volume of the plurality of pores.

In some embodiments, the volume of the second pores may be 72 vol % to 96 vol %, 75 vol % to 95 vol %, 77 vol % to 94.5 vol %, or 78 vol % to 94 vol % based on the total volume of the plurality of pores.

Within the above range, lithium diffusion may be promoted during the manufacturing process of the cathode active material, thereby reducing residual lithium on the cathode active material. Furthermore, the cation mixing ratio may be reduced during the crystallization process of the cathode active material, thereby improving the electrical properties of the secondary battery.

According to exemplary embodiments, the volume of the third pores may be 2 vol % to 25 vol % based on the total volume of the plurality of pores.

In some embodiments, the volume of the third pores may be 2 vol % to 20 vol %, 2.2 vol % to 22 vol %, 2.5 vol % to 21 vol %, 2.8 vol % to 20.5 vol %, or 3.0 vol % to 20.0 vol % based on the total volume of the plurality of pores.

Within the above range, the reaction between the composite hydroxide particles and the lithium precursor may be promoted, thereby increasing the particle growth time and the particle diameter of the cathode active material.

According to exemplary embodiments, the total volume of the plurality of pores may be 0.001 cm³/g to 0.04 cm³/g.

In some embodiments, the total volume of the plurality of pores may be 0.002 cm³/g to 0.038 cm³/g 0.003 cm³/g to 0.035 cm³/g, 0.005 cm³/g to 0.033 cm³/g, or 0.007 cm³/g to 0.031 cm³/g.

Within the above range, lithium may enter the composite hydroxide particles, thereby reducing the pore size or blocking the pores to form a cathode active material in the form of a single particle.

According to exemplary embodiments, the total volume of the plurality of pores may represent the sum of the volumes of the first pores, the second pores and the third pores.

The pore diameter and pore volume may be measured or calculated from the Brunauer-Emmett-Teller (BET) analysis of the composite hydroxide particles. For example, the pore diameter and pore volume may be analyzed based on adsorption-desorption data using known analytical methods (e.g., Barrett-Joyner-Halenda (BJH), Horvath-Kawazoe (HK), or Density Functional Theory (DFT)) in combination with BET analysis. For example, the amount of gas, relative pressure, and temperature, etc., measured during the gas (for example, nitrogen) adsorption/desorption process of the composite hydroxide particles may be measured, and the pore diameter and pore volume of the composite hydroxide particles may be calculated using the measured values and an equation according to the above-described method.

In some embodiments, the BET surface area of the composite hydroxide particles may be 1.0 m²/g to 7.0 m²/g 1.5 m²/g to 6.5 m²/g 2.0 m²/g to 6.0 m²/g 2.5 m²/g to 5.8 m²/g, 2.7 m²/g to 5.5 m²/g, or 2.8 m²/g to 5.0 m²/g.

Within the above range, agglomeration may occur during the reaction between the composite hydroxide particles and the lithium precursor, thereby forming a cathode active material in the form of a single particle with an increased particle size.

The BET surface area may be measured using known methods. For example, the BET surface area may be determined by adsorbing a gas onto the composite hydroxide particles and measuring the amount of the adsorbed gas.

According to exemplary embodiments, the composite hydroxide particles may include one or more metals selected from nickel, cobalt and manganese. For example, the composite hydroxide particles may include nickel, cobalt and manganese. For example, the composite hydroxide particles may include one or more oxides of metals selected from nickel, cobalt and manganese.

According to exemplary embodiments, the content of nickel based on the total content of metals in the composite hydroxide particles may be 80 mol % or more. For example, the content of nickel based on the total content of metals in the composite hydroxide particles may be 82 mol % or more, 85 mol % or more, 88 mol % or more, or 90 mol % or more.

Within the above range, a secondary battery with improved energy density may be provided.

According to exemplary embodiments, the composite hydroxide particles may include a crystal structure of a compound represented by Chemical Formula 1 below.

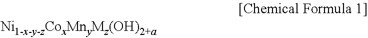

In Chemical Formula 1, x, y, z and a may satisfy 0<x≤0.2, 0<y≤0.2, 0≤z≤0.1, 0.7≤1-x-y-z<1, and −0.1≤a≤0.1, and M may include at least one selected from the group consisting of Na, Mg Ca, Ti, V, Cr, Cu, Zn, Ge, Sr, Ag, Ba, Zr, Nb, Mo, Al, Ga, La, W and B.

For example, x may satisfy 0<x≤0.15, or 0<x≤0.1.

For example, y may satisfy 0<y≤0.15, or 0<y≤0.1.

For example, x, y and z may satisfy 0.8≤1-x-y-z<1, or 0.9≤1-x-y-z<1.

In some embodiments, the composite hydroxide particle may include a crystal structure of a compound represented by Chemical Formula 1-1 below.

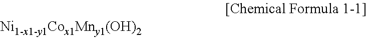

In Chemical Formula 1-1, x1 and y1 may satisfy 0x1≤0.2, 0<y1≤0.2, 0.6<1-x1-y1<1, and M may include at least one selected from the group consisting of Na, Mg Ca, Ti, V, Cr, Cu, Zn, Ge, Sr, Ag, Ba, Zr, Nb, Mo, Al, Ga, La, W and B.

The composite hydroxide particles may have a flake-shaped structure, a needle-shaped structure, or an amorphous structure.

In some embodiments, the composite hydroxide particles may be substantially composed of oxides of nickel, cobalt and manganese. However, other metals are not excluded from the cathode active material including the composite hydroxide particles. For example, nickel, cobalt and manganese may form composite hydroxide particles with controlled pore size, thereby promoting the growth of particle.

According to exemplary embodiments, the composite hydroxide particles may have a flake-shaped structure.

The flake-shaped composite hydroxide particles may induce the lithium precursor and the composite hydroxide particles to agglomerate and grow into a single structure, thereby increasing the particle diameter of the cathode active material in the form of a single particle. For example, when the composite hydroxide particles have a needle-shaped structure or an amorphous structure, the particles may not readily agglomerate, which may reduce the particle diameter of the cathode active material in the form of a single particle.

In some embodiments, the aspect ratio of the composite hydroxide particles may be 1.0 to 6.0, 1.1 to 5.8, 1.15 to 5.5, 1.2 to 5.2, or 1.3 to 5.0.

Within the above range, orientation formation by the composite hydroxide particles may be suppressed, allowing rapid formation of seeds of the cathode active material in the form of a single particle, thereby increasing the particle diameter of the cathode active material.

In some embodiments, the composite hydroxide particles may have a median particle diameter (D₅₀) of 0.1 nm to 5 nm, 0.3 nm to 4 nm, or 0.5 nm to 3 nm.

The “median particle diameter (D₅₀)” may refer to the particle diameter value at which 50% of the volume-based cumulative distribution is reached. The volume cumulative distribution of the particles may be obtained based on a laser diffraction scattering method.

According to the method for preparing a cathode active material precursor of the present disclosure, a mixed solution of a metal source including a nickel source, a cobalt source and a manganese source, and a solvent may be prepared. By reacting the mixed solution, a cathode active material precursor including the composite hydroxide particles may be obtained.

The nickel source, the cobalt source, and/or the manganese source may each include a metal nitrate, sulfate, carbonate or the like. For example, the nickel source may be nickel sulfate, the cobalt source may be cobalt sulfate, and the manganese source may be manganese sulfate.

The contents of the nickel source, cobalt source, and manganese source may be adjusted, respectively, to satisfy the composition of Chemical Formula 1. For example, the molar content of the nickel source, based on the total molar amount of the metals in the metal source, may be 80 mol % or more, 85 mol % or more, or 95 mol % or more.

According to exemplary embodiments, the total concentration of the metal source in the mixed solution may be 0.5 M to 4 M. In some embodiments, the total concentration of the metal source in the mixed solution may be 1 M to 3 M.

The solvent may include an aqueous solvent. For example, the water content in the aqueous solvent may be 70 vol % or more, 90 vol % or more, 95 vol % or more, or 99 vol % or more based on the total volume of the aqueous solvent.

According to exemplary embodiments, the mixed solution may further include a chelating agent or a basic compound.

The chelating agent may include, for example, ammonium hydroxide (NH₃:H₂O), ammonium sulfate ((NH₄)₂SO₄), ammonium nitrate (NH₄NO₃), ammonium chloride (NH₄Cl), ammonium acetate (CH₃COONH₄), ammonium carbonate or the like.

The chelating agent may also include, for example, an organic compound having one carboxyl group. For example, the organic compound having a carboxyl group may include oxalic acid, ethylenediaminetetraacetic acid, citric acid, acetic acid, succinic acid, malonic acid, malic acid, propionic acid, tartaric acid, lactic acid, pyruvic acid, fumaric acid or the like. These may be used alone or in combination of two or more thereof. The content of the chelating agent may be 0.01% by weight (“wt %”) to 3 wt % or 0.05 wt % to 1 wt % based on the total weight of the mixed solution.

According to exemplary embodiments, the concentration of the chelating agent in the mixed solution may be 0.5 M to 4 M, or 1 M to 3 M. In some embodiments, the ratio of the concentration of the chelating agent to the total concentration of the metal source may be 0.5 to 1.5 or 0.7 to 1.2. Within this range, the control of pores may be facilitated.

The basic compound may be added as a precipitant. For example, the basic compound may include sodium hydroxide (NaOH), sodium carbonate (Na₂CO₃), ammonium chloride (NH₄Cl) or the like. These may be used alone or in combination of two or more thereof.

The content of the basic compound may be 0.01 wt % to 3 wt %, or 0.05 wt % to 1 wt % based on the total weight of the mixed solution.

According to exemplary embodiments, the basic compound may be added together with the chelating agent so that the pH of the mixed solution is 11 or more. For example, the pH of the mixed solution may be 11.5 or more, or 12 or more. Accordingly, the proportion of the cathode active material precursor having a flake-shaped structure may increase.

According to exemplary embodiments, the mixed solution may be reacted and dried to form the above-described composite hydroxide particles.

For example, the composite hydroxide particles may be formed through a co-precipitation reaction.

For example, the temperature of the co-precipitation reaction may be 20° C. to 100° C., 40° C. to 80° C., or 50° C. to 75° C. The time of the co-precipitation reaction may be 1 hour to 100 hours, 10 hours to 90 hours, or 20 hours to 80 hours.

For example, the solvent present in the reactant formed through a primary drying may be removed, and pores may be controlled through a secondary drying.

For example, pores may be controlled by adjusting the reaction time, the metal source, the chelating agent, the basic compound, or the reaction temperature. For example, when the reaction time increases, growth of particles may increase, thereby reducing internal pores. For example, when the content of the metal source, the chelating agent, and/or the basic compound increases, the metal source or the like may attach to the internal pores of the formed particles, thereby reducing the internal pores. For example, when the reaction temperature increases, the particles may grow in a direction that decreases the internal pores of the formed particles, thereby reducing the internal pores.

According to the method for preparing a cathode active material of the present disclosure, a mixture of a cathode active material precursor including the above-described composite hydroxide particles and a lithium precursor is subjected to a first heat treatment, followed by a second heat treatment. The first and second heat treatments may be distinguished by temperature.

The cathode active material precursor and the lithium precursor may be mixed in consideration of the total molar amount of metals in the cathode active material precursor and the total molar amount of lithium in the lithium precursor.

According to exemplary embodiments, the cathode active material precursor and the lithium precursor may be mixed so that the ratio of the molar amount of lithium in the lithium precursor to the total molar amount of metals included in the cathode active material precursor is 0.8 to 1.5. In some embodiments, the ratio of the molar amount of lithium in the lithium precursor to the total molar amount of metals included in the cathode active material precursor may be 0.85 to 1.3, or 0.9 to 1.2.

The lithium precursor may include, for example, lithium carbonate, lithium nitrate, lithium acetate, lithium oxide, lithium hydroxide, and the like. These may be used alone or in combination of two or more thereof.

The cathode active material may be prepared by heat-treating the mixture of the cathode active material precursor and the lithium precursor. The cathode active material may include lithium metal oxide particles formed by the reaction between the composite hydroxide particles and the lithium precursor.

According to exemplary embodiments, the lithium metal oxide particles may be in the form of a single particle. The single particle form does not exclude a case where 2 to 10 particles are attached or closely adhered to each other to form a substantially monolithic shape (e.g., a structure converted into a single particle).

For example, lithium metal oxide particles in the form of a single particle may be formed by agglomeration of the above-described composite hydroxide particles with controlled pore volume and the lithium precursor, and the space between the composite hydroxide particles, lithium precursors, and/or a combination thereof may be removed during a heat treatment process.

By adjusting the steps, temperature, and time of the heat treatment, a cathode active material may be prepared that provides a secondary battery with improved electrical properties. For example, by performing heat treatment in two or more stages, damage to particles may be reduced. In addition, by satisfying predetermined relationships between the temperature and time of the first heat treatment and the temperature and time of the second heat treatment, residual lithium on the particle surface may be reduced, and lithium metal oxide particles with sufficiently grown particle diameter and crystallinity may be prepared.

The temperatures and times of the first and second heat treatments may be expressed as the following heat treatment profile value.

According to exemplary embodiments, the heat treatment profile value calculated from the respective times and temperatures of the first and second heat treatments may be 0.5 to 8.

$$Heat treatment profile = ( {T}_{2} \times {t}_{2} ) / ( {T}_{1} \times {t}_{1} ) \qquad [ Equation 1 ]$$

In Equation 1, T₁ is the temperature of the first heat treatment, t₁ is the time of the first heat treatment, T₂ is the temperature of the second heat treatment, and t₂ is the time of the second heat treatment.

The temperatures of the first heat treatment and the second heat treatment may remain constant, or may increase and/or decrease. When the temperatures increase or decrease, the average temperature over time may correspond to the temperature of the first heat treatment and the temperature of the second heat treatment.

In some embodiments, the heat treatment profile value may be 0.5 to 8, 0.6 to 6, 0.7 to 5, 0.8 to 4.5, 0.9 to 4, 1 to 4, 1.1 to 3.8, 1.2 to 3.5, 1.3 to 3.2, 1.5 to 3.0, or 1.7 to 2.5.

Within the above range, the growth of lithium metal oxide particles in the form of a single particle may be promoted. For example, if outside the above range, the particle size may not grow sufficiently or crystallization may not be sufficiently achieved.

Furthermore, while using a cathode active material precursor including composite hydroxide particles with controlled pore volume, by satisfying the heat treatment profile value, a reduction in residual lithium on the surface of the lithium metal oxide particles, an increase in the energy density of the cathode active material, and an improvement in mechanical stability may be achieved.

According to exemplary embodiments, the temperature of the second heat treatment may be lower than the temperature of the first heat treatment.

Therefore, the growth of particle size and crystallization may be performed at a relatively high temperature, thereby increasing the particle diameter of the lithium metal oxide particles.

According to exemplary embodiments, the temperature of the first heat treatment may be 700° C. to 1000° C. In some embodiments, the temperature of the first heat treatment may be 720° C. to 980° C., 750° C. to 950° C., 780° C. to 920° C., 800° C. to 900° C., or 820° C. to 870° C.

Within the above temperature range, the particle size of the composite hydroxide particles may sufficiently grow, reducing the interparticle space and allowing a relatively large amount of composite hydroxide particles to exist in an agglomerated state. The subsequent second heat treatment may perform particle crystallization in the reduced interparticle space, thereby increasing the size of the lithium metal oxide particles in the form of a single particle.

According to exemplary embodiments, the temperature of the second heat treatment may be 600° C. to 800° C. In some embodiments, the temperature of the second heat treatment may be 620° C. to 780° C., 640° C. to 770° C., 660° C. to 760° C., 680° C. to 750° C., or 700° C. to 740° C.

Within the above temperature range, damage to the particles and the formation of residual lithium may be reduced.

According to exemplary embodiments, the temperature difference between the first heat treatment and the second heat treatment may be 50° C. or higher, 70° C. or higher, 80° C. or higher, 90° C. or higher, or 100° C. or higher.

The temperature difference allows particle growth and particle crystallization to be performed separately, thereby increasing the uniformity of the prepared lithium metal oxide particles.

According to exemplary embodiments, the lithium metal oxide particle may include a crystal structure of a compound represented by Chemical Formula 2 below.

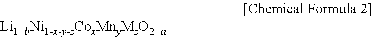

In Chemical Formula 2, x, y, z, a and b may satisfy 0<x≤0.1, 0<y≤0.2, 0≤z≤0.1, 0.7≤1-x-y-z≤1, −0.1≤a≤0.1, and −0.5≤b≤0.5, M may include at least one selected from the group consisting of Na, Mg, Ca, Ti, V, Cr, Cu, Zn, Ge, Sr, Ag, Ba, Zr, Nb, Mo, Al, Ga, La, W and B.

In Chemical Formula 2, M may function as an auxiliary element. The auxiliary element may be incorporated into the layered structure/crystal structure together with the main active elements to form bonds. In addition, the auxiliary element may be added to the main active elements such as nickel, cobalt and manganese to enhance the chemical stability of the cathode active material or the layered structure/crystal structure.

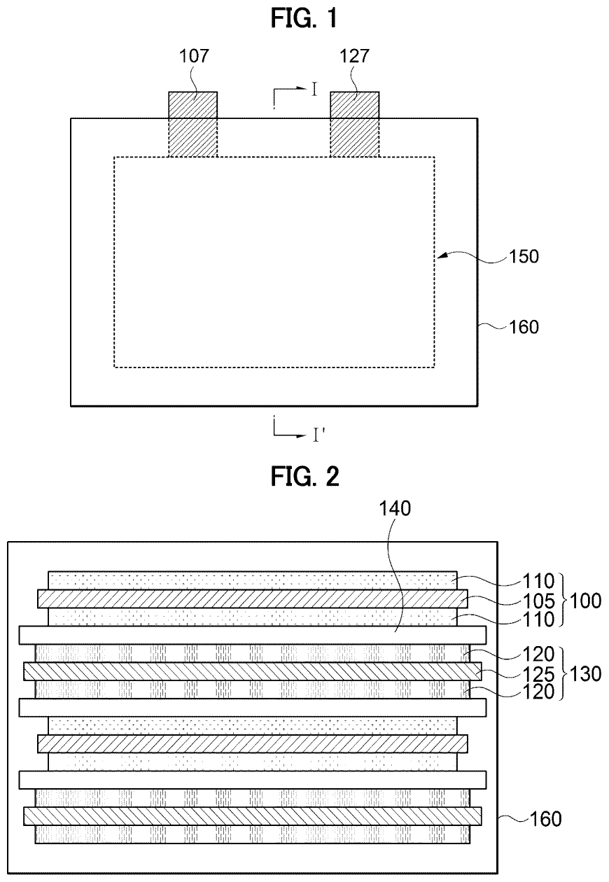

FIGS. 1 and 2 are schematic plan and cross-sectional views, respectively, illustrating a lithium secondary battery according to exemplary embodiments. FIG. 2 is a cross-sectional view taken along line I-I′ of FIG. 1.

Referring to FIGS. 1 and 2, the lithium secondary battery may include an electrode assembly 150 accommodated in a case 160. The electrode assembly 150 may include a cathode 100, an anode 130 and a separator 140, which are repeatedly stacked, as shown in FIG. 2.

The cathode 100 includes a cathode current collector 105 and a cathode active material layer 110 on at least one surface of the cathode current collector 105.

The cathode current collector 105 may include stainless steel, nickel, aluminum, titanium, or an alloy thereof. The cathode current collector 105 may also include aluminum or stainless steel having a surface treated with carbon, nickel, titanium or silver. The cathode current collector 105 may have a thickness of 10 to 50 μm, but is not particularly limited thereto.

The cathode active material layer 110 may also be on both surfaces of the cathode current collector 105.

The cathode active material layer 110 may include a cathode active material. The cathode active material may include the above-described lithium metal oxide.

The cathode active material may further include other cathode active material in addition to the lithium metal oxide. For example, the cathode active material may further include a lithium cobalt oxide-based active material, a lithium manganese oxide-based active material, or a lithium iron phosphate (LFP)-based active material (e.g., LiFePO₄), and may also include a lithium metal oxide that does not have a single-particle structure (e.g., a secondary-particle structure).

The cathode active material layer 110 may further include a conductive material. The conductive material compensates for the reduction in electrical conductivity of the cathode active material layer caused by the binder.

The conductive material may include, for example, carbon-based conductive materials such as graphite, carbon black, acetylene black, Ketjen black, graphene, carbon nanotubes, vapor-grown carbon fibers (VGCFs), and carbon fibers; and/or metal-based conductive materials such as tin, tin oxide, and titanium oxide; and perovskite materials such as LaSrCoO₃, and LaSrMnO₃. For example, the conductive material may include carbon nanotubes

The content of the conductive material based on the total weight of the cathode active material layer may be 0.01 wt % to 3 wt %. In some embodiments, the content of the conductive material based on the total weight of the cathode active material layer may be 0.1 wt % to 1 wt %.

The cathode active material layer may further include a binder. The binder may bind the cathode active material and the conductive material, and may enhance the adhesion between the cathode active material layer and the cathode current collector.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as a binder for forming the cathode. In this case, the amount of the binder for forming the cathode active material layer may be reduced and the amount of the cathode active material may be relatively increased, thereby improving the output and capacity of the secondary battery.

The content of the binder may be 0.5 wt % to 5 wt % based on the total weight of the cathode active material layer. In some embodiments, the content of the binder may be 1 wt % to 3 wt %/o based on the total weight of the cathode active material layer.

The cathode active material layer may further include a thickener and/or a dispersant. For example, the cathode active material layer may include a thickener such as carboxymethyl cellulose (CMC).

The cathode active material layer 110 may be formed from a cathode slurry composition including a cathode active material and a binder. For example, the cathode active material layer 110 may be prepared by applying the cathode slurry composition including a cathode active material and a binder to a surface of the cathode current collector 105, and then drying and roll-pressing the applied layer.

According to exemplary embodiments, the cathode slurry composition may include a solvent. As the solvent, N-methyl-2-pyrrolidone (NMP), dimethylformamide, dimethylacetamide, N,N-dimethylaminopropylamine, ethylene oxide, tetrahydrofuran, and the like may be used.

The application of the cathode slurry composition may be performed using methods such as gravure coating slot die coating simultaneous multilayer die coating imprinting doctor blade coating dip coating bar coating or casting etc., but is not limited thereto.

According to exemplary embodiments, the cathode active material layer may have thickness of, for example, 10 μm to 200 μm, but is not particularly limited thereto.

According to some embodiments, the cathode active material layer may include two or more layers including different types of cathode active materials, conductive materials, and/or binders. For example, the cathode active material layer may include a first cathode active material layer and a second cathode active material layer, and the type and/or content of the active material, conductive material, and/or binder in the first cathode active material layer may be different from the type and/or content of the active material, conductive material, and/or binder in the second cathode active material layer.

The anode 130 may include an anode current collector 125 and an anode active material layer 120, which is formed by coating an anode active material on the anode current collector 125.

The anode active material may include a material capable of absorbing and releasing lithium ions. For example, carbon-based materials such as crystalline carbon, amorphous carbon, carbon composites, carbon fibers, etc.; a lithium alloy; silicon or tin may be used.

Examples of the amorphous carbon may include hard carbon, coke, mesocarbon microbead (MCMB) calcined at 1500° C. or lower, mesophase pitch-based carbon fiber (MPCF) or the like. Examples of the crystalline carbon may include graphite-based carbon such as natural graphite, graphitized coke, graphitized MCMB, graphitized MPCF or the like. Other elements included in the lithium alloy may include, for example, aluminum, zinc, bismuth, cadmium, antimony, silicon, lead, tin, gallium, indium or the like.

The anode current collector 125 may include, for example, gold, stainless steel, nickel, aluminum, titanium, copper, or an alloy thereof, and preferably includes copper or a copper alloy.

In some embodiments, a slurry may be prepared by mixing the anode active material with a binder, a conductive material and/or a dispersant in a solvent, followed by stirring the mixture. The slurry may be coated on at least one surface of the anode current collector 125, followed by compression and drying to prepare the anode 130.

As the binder and the conductive material, materials which are substantially the same as or similar to the above-described materials used in the cathode active material layer 110 may be used. In some embodiments, a binder for forming an anode may include, for example, an aqueous binder such as styrene-butadiene rubber (SBR) to ensure compatibility with a carbon-based active material, and may be used together with a thickener such as carboxymethyl cellulose (CMC).

The separator 140 may be interposed between the cathode 100 and the anode 130. The separator 140 may include a porous polymer film made of a polyolefin polymer such as ethylene homopolymer, propylene homopolymer, ethylene/butene copolymer, ethylene/hexene copolymer, or ethylene/methacrylate copolymer. The separator 140 may include a non woven fabric made of glass fibers having a high melting point, polyethylene terephthalate fibers, etc.

In some embodiments, the anode 130 may have an area (e.g., a contact area with the separator 140) and/or volume greater than that of the cathode 100. Thereby, lithium ions generated from the cathode 100 may migrate smoothly to the anode 130, for example, without being precipitated during the process. Therefore, effects of simultaneously improving output and stability through a combination of the above-described first cathode active material layer and the second cathode active material layer may be more easily realized.

According to exemplary embodiments, an electrode cell is defined by the cathode 100, the anode 130, and the separator 140, and a plurality of electrode cells may be stacked to form, for example, a jelly roll type electrode assembly 150. For example, the electrode assembly 150 may be formed by winding stacking or folding the separator 140.

The electrode assembly 150 may be accommodated in the case 160 together with an electrolyte to define the lithium secondary battery. According to exemplary embodiments, anon-aqueous electrolyte may be used as the electrolyte.

The non-aqueous electrolyte may include a lithium salt and an organic solvent. The lithium salt is represented by, for example, Li⁻X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂CH⁻, (SF₅)₃C⁻, (CF₃SO₂C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethylsulfuroxide, acetonitrile, dimethoxyethane, diethoxyethane, vinylene carbonate, sulfolane, γ-butyrolactone, propylene sulfite and tetrahydrofuran, etc. may be used. These may be used alone or in combination of two or more thereof.

As shown in FIG. 1, electrode tabs (cathode tabs and anode tabs) may protrude from the cathode current collector 105 and the anode current collector 125, respectively, which belong to each electrode cell, and may extend to one side of the case 160. The electrode tabs may be welded together with the one side of the case 160 to form electrode leads (a cathode lead 107 and an anode lead 127) that extend or are exposed to an outside of the case 160.

FIG. 1 shows that the cathode lead 107 and the anode lead 127 protrude from an upper side of the case 160 in a planar direction, but positions of the electrode leads are not limited thereto. For example, the electrode leads may protrude from at least one of both sides of the case 160, or may protrude from a lower side of the case 160. Alternatively, the cathode lead 107 and the anode lead 127 may be formed so as to protrude from different sides of the case 160, respectively.

The lithium secondary battery may be manufactured, for example, in a cylindrical shape, a prismatic shape, a pouch shape or a coin shape using a can, or the like.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### Example 1

### (1) Preparation of Cathode Active Material Precursor

Nickel sulfate (NiSO₄), cobalt sulfate (CoSO₄), and manganese sulfate (MnSO₄) were mixed at a ratio of 0.8:0.1:0.1 using distilled water from which dissolved oxygen had been removed by bubbling N₂ for 24 hours. The mixed solution was then placed in a reactor at 70° C., and sodium hydroxide (NaOH) as a precipitant and ammonium hydroxide (NH₃:H₂O) as a chelating agent were added to adjust the pH to 12.0. The transition metal and ammonium hydroxide (NH₃:H₂O) were added at a concentration ratio of 1:1. A co-precipitation reaction was then conducted for 72 hours to obtain Ni_{0.8}Co_{0.1}Mn_{0.1}(OH)₂ as a transition metal precursor. The obtained transition metal precursor was dried at 100° C. for 12 hours and then further dried at 120° C. for 10 hours to prepare a cathode active material precursor including transition metal precursor particles.

### (2) Properties of Cathode Active Material Precursor

The specific surface area, pore volume, and aspect ratio of the transition metal precursor particles were measured.

The specific surface area and pore volume were measured using a BET analyzer (Micromeritics, ASAP 2420) according to the gas adsorption/desorption method. Pores were classified into micropores (2 nm or less), mesopores (greater than 2 nm and less than 50 nm), and macropores (50 nm or more) based on their diameters.

The aspect ratio was measured using photographs of the cathode active material precursor particles taken with a scanning electron microscope (SEM) (Helios Nanolab 650, Thermo Fisher Scientific).

### (3) Preparation of Cathode Active Material

Lithium hydroxide (LiOH) and the cathode active material precursor were added to dry high-speed mixer at a ratio of 1.01:1 and mixed uniformly for 20 minutes. The mixture was placed in a calcination furnace and heated to 830° C. at a heating rate of 2° C./min and maintained for 5 hours for a first heat treatment. The temperature was then reduced to 720° C. and maintained for 10 hours for a second heat treatment.

Oxygen was continuously supplied at a flow rate of 10 mL/min during the heating and maintaining. After completion of the calcination, the mixture was allowed to cool naturally to room temperature. Then, the calcined product was pulverized and classified to prepare a cathode active material including lithium metal oxide particles having a composition of LiNi_{0.8}Co_{0.1}Mn_{0.1}O₂ in the form of a single particle.

The specific surface area, aspect ratio, and pore volume of the transition metal precursor particles are shown in Table 1.

### Examples 2 to 8

Cathode active material precursors and cathode active materials were prepared in the same manner as in Example 1, except that the specific surface area, aspect ratio, and pore volume of the transition metal precursor were changed according to Table 1 by adjusting the reactor temperature and reaction time, and the amounts and ratios of the transition metal, sodium hydroxide (NaOH), and ammonium hydroxide (NH₃:H₂O) added.

### Examples 9 to 13

Cathode active materials were prepared in the same manner as in Examples 1 to 5, except that in the preparation of the cathode active material, the first heat treatment was performed by heating to 720° C. and maintaining it for 10 hours, and the second heat treatment was performed by increasing the temperature to 830° C. and maintaining it for 5 hours.

### Comparative Examples 1 and 2

Cathode active material precursors and cathode active materials were prepared in the same manner as in Example 1, except that in the preparation of the cathode active material, the specific surface area, aspect ratio, and pore volume of the transition metal precursor particles were changed according to Table 1 below by adjusting the reactor temperature and reaction time, and the amounts and ratios of the transition metal, sodium hydroxide (NaO), and ammonium hydroxide (NH₃·H₂) added.

### Comparative Examples 1 to 7

Cathode active materials were prepared in the same manner as in Examples 1 to 5, except that in the preparation of the cathode active material, the heat treatment was performed by heating to 830° C. and maintaining it for 10 hours.

TABLE 1

| | Transition metal precursor particles | | | | | |
|---|---|---|---|---|---|---|
| | BET | Pore properties | | | | |
| | specific | Total | | | | |
| | surface | pore | Micro- | Meso- | Macro- | |
| Classi- | area | volume | pores | pores | pores | Aspect |
| fication | (m²/g) | (cm³/g) | (vol %) | (vol %) | (vol %) | ratio |
| Example 1 | 2.98 | 0.0188 | 1.6 | 89.4 | 9.0 | 1.5 |
| Example 2 | 2.89 | 0.0083 | 3.1 | 93.7 | 3.2 | 1.4 |
| Example 3 | 3.05 | 0.0302 | 0.8 | 79.6 | 19.6 | 1.5 |
| Example 4 | 5.38 | 0.0202 | 1.4 | 87.8 | 10.8 | 5.5 |
| Example 5 | 8.40 | 0.0214 | 1.3 | 87.1 | 11.6 | 7.9 |
| Example 6 | 3.32 | 0.0165 | 4.5 | 90.3 | 5.2 | 2.1 |
| Example 7 | 2.83 | 0.0393 | 1.6 | 70.2 | 28.2 | 2.5 |
| Example 8 | 3.12 | 0.0203 | 0.6 | 98.3 | 1.1 | 2.6 |
| Comparative | 2.76 | 0.0251 | — | 85.3 | 14.7 | 2.6 |
| Example 1 | | | | | | |
| Comparative | 9.86 | 0.0255 | 8.8 | 75.4 | 15.8 | 6.5 |
| Example 2 | | | | | | |

### Manufacture of Secondary Battery

The cathode active material, carbon black as a conductive material, and PVDF as a binder were mixed at a weight ratio of 93:5:2 and dispersed in N-methylpyrrolidone to prepare a slurry. The slurry was applied to one surface of an aluminum current collector (thickness: 20 μm), and then dried and roll-pressed to prepare a cathode.

A lithium metal 1.2 T was used for the anode.

The cathode and anode were notched to a predetermined size, stacked, and a separator (polyethylene, thickness: 13 μm) was interposed between the cathode and the anode. An electrolyte was then injected to prepare a 2032-type coin cell.

As the electrolyte, a solution (concentration of LiPF₆:1 M) in which LiPF₆ was dissolved in a solvent mixture of ethylene carbonate and ethyl methyl carbonate at a volume ratio of 1:2 was used.

### Experimental Example

### (1) Evaluation of Cathode Active Material Precursor

### Evaluation of SEM Images

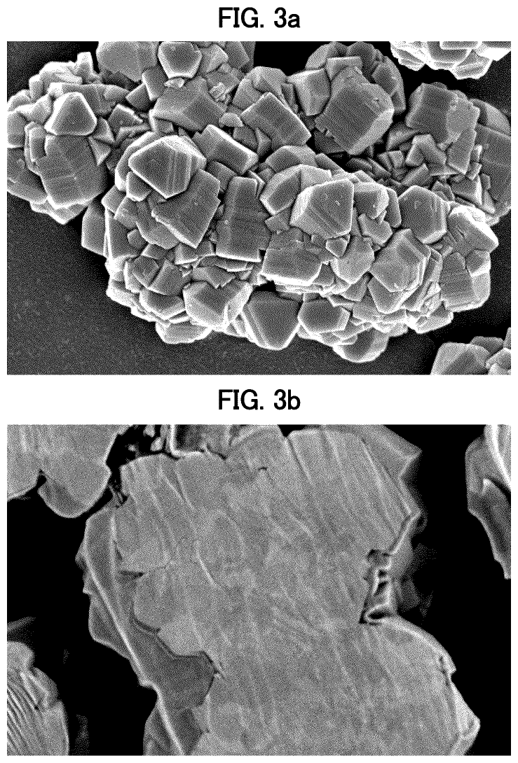

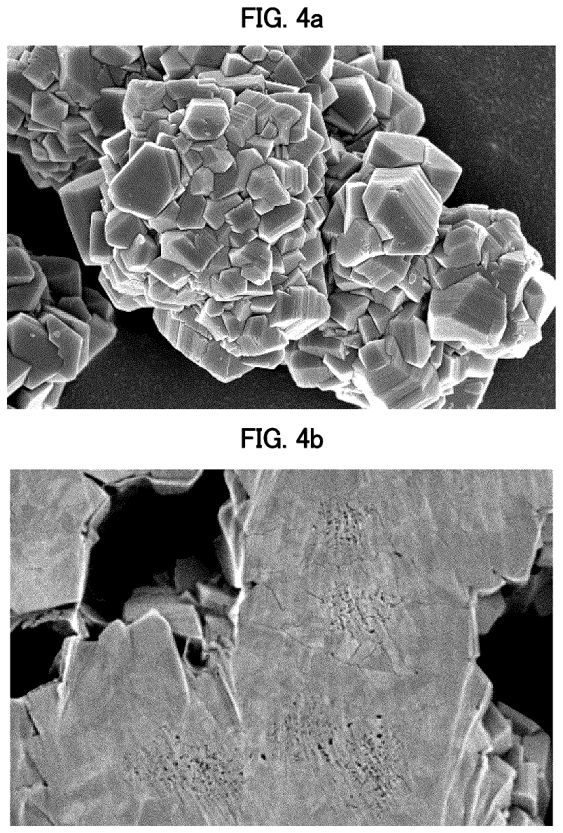

The SEM images of the cathode active material precursor according to Example 1 are shown in FIGS. 3A and 3B, and the SEM images of the cathode active material precursor according to Example 3 are shown in FIGS. 4A and 4B. The SEM images of the cathode active material precursor according to Comparative Example 2 are shown in FIGS. 5A and 5B.

Referring to FIGS. 3A, 3B, 4A and 4B, it was confirmed that even though the cathode active material precursors had the same flake-shaped structure and similar BET values, the pore volumes could differ.

Referring to FIGS. 5A and 5B, in the cathode active material precursor having a needle-shaped structure, numerous large pores were observed.

### (2) Evaluation of Cathode Active Material

### Evaluation of SEM Images

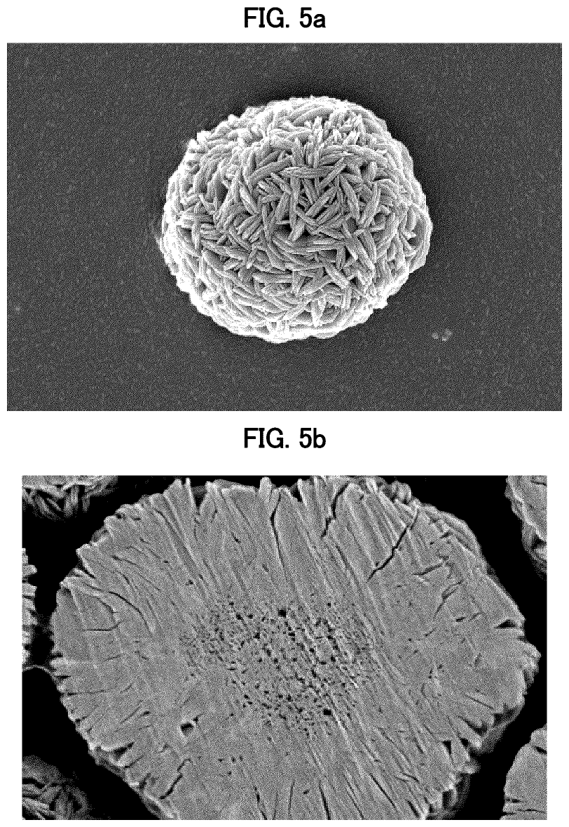

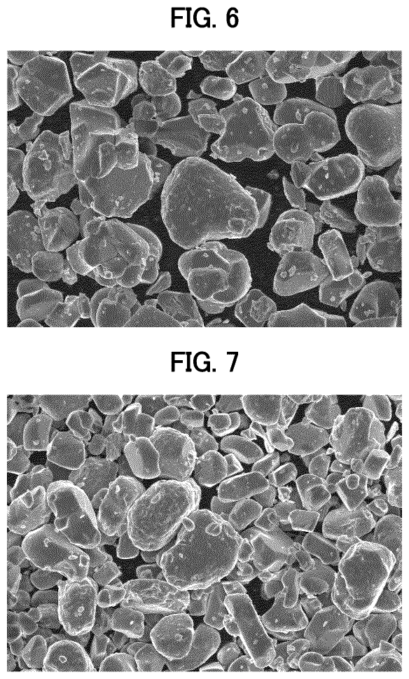

The SEM image of the cathode active material prepared using the cathode active material precursor according to Example 1 is shown in FIG. 6, and the SEM image of the cathode active material prepared using the cathode active material precursor according to Comparative Example 2 is shown in FIG. 7.

Referring to FIGS. 6 and 7, the cathode active material according to Example 1 exhibited a larger average particle size and higher uniformity than the cathode active material according to Comparative Example 2.

### Measurement of Residual Lithium

2.5 g of the cathode active material according to each of the examples and comparative examples was placed in a 250 mL beaker, followed by adding 100 g of deionized water. A magnetic bar was added and stirred at 300 rpm for 10 minutes. The mixture was then filtered using a vacuum flask, and 100 g of the filtrate was collected. The aliquot was placed in an autotitrator vessel and automatically titrated with 0.1NHCl according to the Warder method to measure the Li₂CO₃ and LiOH contents in the solution.

### Measurement of Particle Diameter

The particle size distribution of the cathode active material was measured using the laser diffraction method (Microtrac, MT 3000). The D₅₀ of the cathode active material was calculated as the particle diameter at the 50% point of the volume-based particle size distribution.

### (3) Evaluation of Secondary Battery

### Measurement of Initial Charge-Discharge Capacity

The secondary batteries manufactured according to the examples and comparative examples were charged (CC-CV 0.1 C 4.3 V 0.005 C cut-off) in a chamber at 25° C., and the battery capacity (initial charge capacity) was measured. The batteries were then discharged (CC 0.1 C 3.0 V cut-off), and the battery capacity (initial discharge capacity) was measured.

### Evaluation of Rate Properties

The secondary batteries manufactured according to the examples and comparative examples were charged (CC/CVO0.1 C, 4.3 V, 0.005 C cut-off) and discharged (CC 0.1 C, 3.0 V cut-off) twice. They were then charged (CC/CV 0.5 C, 4.3 V, 0.005 C cut-oft) and discharged (CC 4.0 C, 3.0V cut-oft) once more. The rate properties were evaluated by dividing the discharge capacity at 4.0 C by the discharge capacity at 0.1 C, and covering the (value into percentage (%).

The results of the cathode active material and secondary battery evaluations are shown in Table 2.

TABLE 2

| | Evaluation of cathode active | | | |
|---|---|---|---|---|
| | material | | Evaluation of secondary | |
| | | Median | battery | |
| | Residual | particle | Discharge | Rate |
| | lithium | diameter (D₅₀) | capacity | properties |
| Classification | (ppm) | (nm) | (mAh/g) | (%) |
| Example 1 | 11120 | 3.95 | 208.9 | 86.4 |
| Example 2 | 11180 | 3.77 | 208.8 | 85.2 |
| Example 3 | 11090 | 3.75 | 209.0 | 85.1 |
| Example 4 | 11500 | 3.81 | 208.7 | 84.7 |
| Example 5 | 12090 | 3.75 | 208.2 | 84.5 |
| Example 6 | 12000 | 2.89 | 205.8 | 78.2 |
| Example 7 | 12150 | 2.78 | 206.1 | 77.5 |
| Example 8 | 12300 | 2.93 | 205.1 | 76.9 |
| Example 9 | 12570 | 3.77 | 208.5 | 83.2 |
| Example 10 | 12580 | 3.82 | 208.5 | 83.3 |
| Example 11 | 12550 | 3.79 | 208.3 | 83.5 |
| Example 12 | 12720 | 3.72 | 208.0 | 82.7 |
| Example 13 | 12840 | 3.68 | 207.6 | 82.5 |
| Comparative | 17050 | 4.12 | 201.1 | 68.3 |
| Example 1 | | | | |
| Comparative | 13580 | 3.38 | 202.3 | 75.3 |
| Example 2 | | | | |
| Comparative | 16770 | 3.68 | 204.5 | 74.1 |
| Example 3 | | | | |
| Comparative | 16980 | 3.58 | 204.2 | 73.5 |
| Example 4 | | | | |
| Comparative | 16750 | 3.57 | 204.4 | 73.2 |
| Example 5 | | | | |
| Comparative | 16520 | 3.62 | 204.7 | 71.0 |
| Example 6 | | | | |
| Comparative | 16280 | 3.57 | 204.8 | 70.8 |
| Example 7 | | | | |

Referring to Table 2, the content of lithium remaining on the surface of the cathode active materials according to the examples was reduced. In addition, the discharge capacity of the secondary batteries according to the examples increased, and their rate properties improved.

In Example 6, which had a relatively high micropore volume, Example 7, which had a relatively low mesopore volume, and Example 8, which had a relatively high mesopore volume, the discharge capacity and rate properties of the secondary batteries relatively degraded.

The content of lithium remaining on the surface of the cathode active materials according to the comparative examples increased. Furthermore, the discharge capacity of the secondary batteries according to the comparative examples decreased, and their rate properties were significantly degraded.

What is claimed is:

1. A cathode active material precursor comprising composite hydroxide particles including a plurality of pores, wherein the composite hydroxide particles comprise first pores having a diameter of 2 nm or less in a volume of 0.1 to 5% by volume based on a total volume of the plurality of pores.

2. The cathode active material precursor according to claim 1, wherein the composite hydroxide particles comprise second pores having a diameter of greater than 2 nm and less than 50 nm in a volume of 70 to 97% by volume based on the total volume of the plurality of pores.

3. The cathode active material precursor according to claim 2, wherein the composite hydroxide particles comprise third pores having a diameter of 50 nm or more in a volume of 2 to 25% by volume based on the total volume of the plurality of pores.

4. The cathode active material precursor according to claim 1, wherein the composite hydroxide particles have a BET surface area of 1.0 m²/g to 7.0 m²/g.

5. The cathode active material precursor according to claim 1, wherein the total volume of the plurality of pores of the composite hydroxide particles is 0.001 cm³/g to 0.04 cm³/g.

6. The cathode active material precursor according to claim 1, wherein the composite hydroxide particles have an aspect ratio of 1.0 to 6.0.

7. The cathode active material precursor according to claim 1, wherein the composite hydroxide particles include nickel, cobalt and manganese, and the content of nickel based on the total content of metals in the composite hydroxide particles is 80 mol % or more.

8. A method of preparing a cathode active material comprising:
first heat-treating a mixture of a cathode active material precursor and a lithium precursor, the cathode active material precursor comprising composite hydroxide particles including a plurality of pores, wherein first pores having a diameter of 2 nm or less have a volume accounting for 0.1 to 5% by volume of a total volume of the plurality of pores; and
second heat-treating the mixture,
wherein a heat treatment profile value, according to Equation 1 below, is 0.5 to 8:
$$Heat treatment profile = ( {T}_{2} \times {t}_{2} ) / ( {T}_{1} \times {t}_{1} ) \qquad [ Equation 1 ]$$
wherein, in Equation 1, T₁ is a temperature of the first heat treatment, t₁ is a time of the first heat treatment, T₂ is a temperature of the second heat treatment, and t₂ is a time of the second heat treatment.

9. The method of preparing a cathode active material according to claim 8, wherein the heat treatment profile value is 1 to 4.

10. The method of preparing a cathode active material according to claim 8, wherein the temperature of the second heat treatment is lower than the temperature of the first heat treatment.

11. The method of preparing a cathode active material according to claim 8, wherein the composite hydroxide particles comprise second pores having a diameter greater than 2 nm and less than 50 nm in a volume of 70 to 97% by volume based on the total volume of the plurality of pores.

12. The method of preparing a cathode active material according to claim 8, wherein the composite hydroxide particles comprise third pores having a diameter of 50 nm or more in a volume of 2 to 25% by volume based on the total volume of the plurality of pores.

13. The method of preparing a cathode active material according to claim 8, wherein the composite hydroxide particles have a BET surface area of 1.0 m²/g to 7.0 m²/g.

14. The method of preparing a cathode active material according to claim 8, wherein the total volume of the plurality of pores of the composite hydroxide particles is 0.001 cm³/g to 0.04 cm³/g.

15. The method of preparing a cathode active material according to claim 8, wherein the composite hydroxide particles have an aspect ratio of 1.0 to 6.0.

16. The method of preparing a cathode active material according to claim 8, wherein the temperature of the first heat treatment is 700° C. to 1000° C.

17. The method of preparing a cathode active material according to claim 8, wherein the temperature of the second heat treatment is 600° C. to 800° C.

18. The method of preparing a cathode active material according to claim 8, wherein the composite hydroxide particles include nickel, cobalt and manganese, and the content of nickel based on the total content of metals in the composite hydroxide particles is 80 mol % or more.

19. The method of preparing a cathode active material according to claim 8, wherein the composite hydroxide particles have a flake-shaped structure.

20. The method of preparing a cathode active material according to claim 8, wherein a cathode active material in a form of a single particle is formed.
